(19) United States
(12) Patent Application Publication
(10) Pub. No.: US 2006/0136894 A1
(43) Pub. Date: Jun. 22, 2006

(54) Diagram artifact synchronization resiliency with orphaned shapes

(75) Inventors: Giovanni Stallo, Redmond, WA (US); Jeremy Mercer, Woodinville, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/019,776

(22) Filed: Dec. 21, 2004

(51) Int. Cl. G06F 9/44

(52) U.S. Cl. 717/168; 717/120; 717/113; 717/109

(57) ABSTRACT

A software diagram is created based on software artifacts for a software program, where the software diagram comprises shapes corresponding to software artifacts. The diagram shapes may be customized to illustrate certain properties of the software artifacts or relationships between the software artifacts. Later, one or more changes are made to one or more of the software artifacts such that the diagram no longer accurately reflects the program code. A diagramming tool attempts to automatically update the software diagram to reflect the changed program code, but may be unable to account for at least one diagram shape because its associated software artifact has changed such that the diagramming tool no longer recognizes it as the same software artifact. The unaccounted for shape is known as an orphaned shape. A user may instruct the diagramming tool to associate the orphan shape with one of the changed software artifacts. The diagramming tool automatically reapplies the customizations previously associated with the orphan shape using the properties of the changed software artifact where applicable.

### FIELD OF THE INVENTION

The invention relates to the field of modeling diagrams. More specifically, the invention relates to systems and methods for synchronizing concepts expressed on modeling diagrams with those of the underlying artifacts.

### BACKGROUND OF THE INVENTION

Early software diagramming tools allowed users to draw diagrams that modeled abstract concepts such as objects, object inheritance, and data structures, to help design and describe complex object-oriented systems. Later, the addition of code structure generation features allowed users to take these models and generate software artifacts such as code stubs, header files, interface description files, and other code structures that the model represented. Further improvements of tools enabled users to go the other way and automatically generate diagrams from existing software artifacts. Often such graphical visualizations are useful for abstracting key details of a large collection of code structures, and the inherent relationships between them, to gain an understanding of a system or software application.

An improvement was to allow changes made in one representation to be reflected in another in a continuous fashion. For example, after initially generating code from a diagram, the code might undergo changes during implementation due to the introduction of design changes and other implementation considerations. After these code changes, it is highly desirable for the original diagram to be updated in an automated fashion and remain an accurate representation of the underlying software artifacts. These diagrams are a common means for communicating designs between team members and are often published as system documentation. Therefore, ensuring the accuracy of the information presented is very desirable.

When an abstract modeling diagram is resynchronized with underlying software artifacts, it must be able to re-associate existing shapes on the diagram with the software artifacts they represent in order to update the diagram. Software artifacts often undergo significant changes including but not limited to renaming, changing namespaces, and changing source code filenames. Some tools have heuristics for this shape-to-code linking, but all invariably fail at one point or another. Inherent ambiguities in the mapping between artifacts and model elements make this process subject to occasional irregularities.

When a diagram cannot be automatically updated, it requires manual intervention by the user in order to again make it the desired representation of the software artifacts. This involves tasks like re-adding shapes to the diagram, fixing up layout, line routing, etc. This “fix up” task often involves duplicating significant work that has already been done in the original creation of the diagram.

Therefore, what is needed are systems and methods for updating a diagram to reflect changes to software artifacts while preserving previous diagram customizations.

### SUMMARY OF THE INVENTION

A software diagram may be created based on software artifacts of a software application with a diagramming tool. The software diagram comprises shapes corresponding to software artifacts in the program code. The shapes on the diagram may be customized to point out, or emphasize, certain properties of the software artifacts or relationships between the software artifacts. The diagram, including the shape customizations, is desirably saved. One or more changes subsequently may be made to one or more of the software artifacts of the program code such that the software diagram no longer accurately reflects the software artifacts. The diagramming tool desirably attempts to automatically reconstruct the diagram from the changed software artifacts, but may be unable to account for all of the discrepancies between diagram shapes representing modeling abstractions and underlying software artifacts. In cases where discrepancies exist, orphan shapes are substituted for regular shapes. The diagramming tool prompts a user regarding the orphan shape. If the orphan shape corresponds to one of the shapes on the previous diagram, e.g., it represents a software artifact that had a name change, the user desirably instructs the diagramming tool that the orphan shape is related to the previous shape. The diagramming tool desirably applies the customizations of the previously stored shape to the orphan shape, and updates the visual relationships between the shapes if applicable. If the orphan shape corresponds to some modeling abstraction that has been removed from the underlying software artifacts, then the orphan shape is deleted by the user.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an exemplary screen shot of a software diagramming system in accordance with the present invention;

FIG. 2 is another exemplary screen shot of a software diagramming system in accordance with the present invention;

FIG. 3 is another exemplary screen shot of a software diagramming system in accordance with the present invention;

FIG. 4 is another exemplary screen shot of a software diagramming system in accordance with the present invention;

FIG. 5 is a flow diagram illustrating an exemplary method for software diagram shape synchronization in accordance with the present invention;

FIG. 6 is a block diagram of an exemplary software diagramming system in accordance with the present invention; and

FIG. 7 is a block diagram showing an exemplary computing environment in which aspects of the invention may be implemented.

### DETAILED DESCRIPTION OF ILLUSTRATIVE EMBODIMENTS

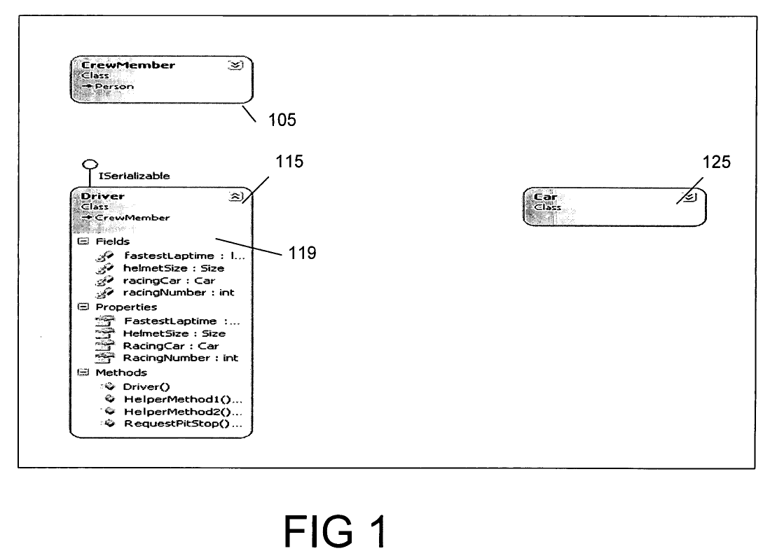

FIGS. 1, 2, 3 and 4 are exemplary screen shots of a software diagramming system in accordance with the present invention. A software diagram is a graphical representation of a software project. A software diagram comprises a plurality of shapes, as shown on FIG. 1 at 105, 115, and 125, for example. While the software diagrams are shown comprising three shapes, it is for illustrative purposes only, and not meant to limit the invention to diagrams comprising only three shapes. There is no limit to the number of shapes that can be supported by the present invention. In addition, the following description includes detail regarding software artifacts including classes and objects. The descriptions are for example only and not meant to limit the invention to the particular details or examples described.

Each of the shapes on the software diagram desirably correspond to software artifacts found in the associated software project. Software artifacts can comprise the inputs used to create a software application. Examples of software artifacts include source code files, Interface Description Language files, resource description files, resource files, component licensing files, classes, structures, enumerations, delegates, and interfaces, for example. The software diagram may have been generated from the associated software artifacts automatically, or manually by a user or programmer associated with the software project, for example. Any system, method, or technique known in the art for generating a software diagram from software artifacts may be used.

As shown in FIG. 1, shape 105 corresponds to a class CrewMember that inherits from the class Person. Shape 115 corresponds to a class Driver that inherits from the class CrewMember, and shape 125 corresponds to a class Car. Each shape as shown desirably has associated customizations. Customizations desirably relate to the presentation of the shapes and may include cosmetic options, such as shape color, size, shape, and location on the screen, for example. The customizations may also illustrate certain details or properties regarding the associated software artifacts. For example, shape 115 as shown in FIG. 1, lists each of the methods, properties and fields associated with the underlying software artifact. In addition, a ‘lollipop’ shape is shown signifying that the Driver class, represented by shape 115, implements the interface ISerializable. In contrast, shapes 105 and 115 are shown without any related methods, fields or properties. The user or developer is desirably able to change or modify the level of detail associated with each shape by changing the associated customizations. The customizations are desirably saved along with the diagram. While the embodiment is described with reference to specific customizations and software artifacts, it is not meant to limit the invention to the customizations or software artifacts described. The invention can support any software diagram customizations and software artifacts known in the art.

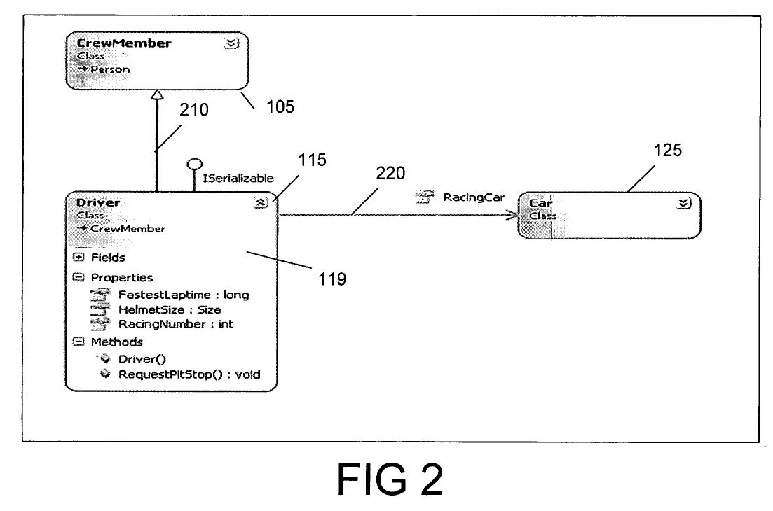

As shown in the exemplary screen shot at FIG. 2, a user or developer has desirably made some changes to the customizations associated with one or more of the shapes. For example, as described previously the class Driver inherits from the class CrewMember. Accordingly, the user has emphasized this inheritance by visualizing it via an inheritance line 210 connecting shape 115 with shape 105. Similarly, the user or developer may wish to illustrate that each class of type Driver contains a reference to a class of type Car through a property named RacingCar. As shown, the user has illustrated this relationship by visualizing it as association line 220 between shapes 115 and 125.

The user or developer may also make cosmetic customizations to the diagram. For example, the user or developer has made several cosmetic changes to shape 115. Compartment 119 on shape 115 has been collapsed to hide all of the member fields associated with the Driver class. These fields still exist in the underlying software artifacts, though they are no longer visualized on the diagram. The shape width has been increased to better view and display the associated properties and methods text. The user has also hidden both HelperMethod1 and HelperMethod2, as they may be a level of detail that is undesirable for the diagram, for example. In addition, the ‘lollipop’ shape has been repositioned in order to not visually conflict with the inheritance line 210, for example.

After making the diagram customizations as shown in FIG. 2, the user desirably saves the diagram and closes it. As work progresses in the software project, the underlying source code files and other software artifacts are desirably modified. For example, assume the name of class Driver has been renamed RacingDriver.

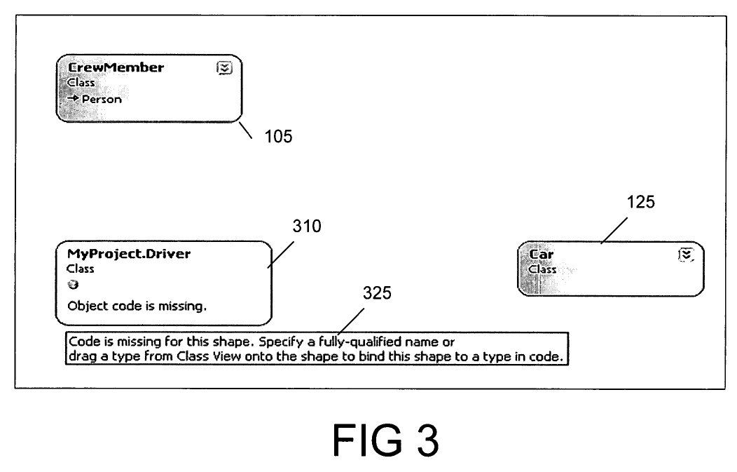

As shown in FIG. 3, the application diagram is reopened and there may be a problem updating the software diagram to reflect the latest software artifact changes. The shape 115 corresponded to a class called ‘Driver’ but it cannot be found because of the name change to RacingDriver. Accordingly, after updating the diagram, shape 115 and its associated customizations, arrows 220, and 210, as well as the size and layout customizations, have been removed. Instead, a new temporary orphan shape 310 has desirably replaced shape 115. Orphan shape 310 is a place holder for the previous shape 115. The diagramming tool desirably informs or prompts the user that there is now a disconnect between the software diagram and the underlying software artifacts. The prompt may be in the form of a tool tip or text box, for example, as shown at 325. The prompt may contain instructions on how the user can re-link the shape to a software artifact. Any system, method, or technique known in the art for prompting a user may be used.

In response to the prompt, the user desirably either re-links, or otherwise associates, the orphan shape 310 with one of the current software artifacts, or the user may delete the orphan shape 310 from the software diagram. For example, the user may edit the orphan shape 310 to point to the software artifact MyProject.RacingDriver. The user may edit the orphan shape by typing the name of the new software artifact into the orphan shape 310. Alternatively, there may be a software artifact window (not shown) comprising the names of all the software artifacts associated with the software application. The window desirably comprises all of the available software artifacts in the software project regardless of whether they have been selected to appear on the software diagram. The user desirably selects the software artifact corresponding to RacingDriver from the window and may drag it onto the orphan shape 310 to establish the association, for example. Any system, method, or technique known in the art for associating objects in a computer system may be used.

Once the user re-links the orphan shape 310 with the software artifact RacingDriver, the diagramming tool desirably applies the customizations associated with the orphan shape 310 with the software artifact corresponding to the class RacingDriver. As described previously, orphan shape 310 was created in response to the renaming of the software artifact associated with shape 115. Instead of deleting the customizations associated with shape 115, the customizations were desirably saved along with orphan shape 310, such that if orphan shape 310 was re-linked or otherwise associated with another software artifact, the customizations previously applied to shape 115 could be applied to the new shape. Accordingly, once the user has selected to associate the class RacingDriver with orphan shape 310, the diagramming tool desirably retrieves the saved customizations and applies them to the class RacingDriver where applicable.

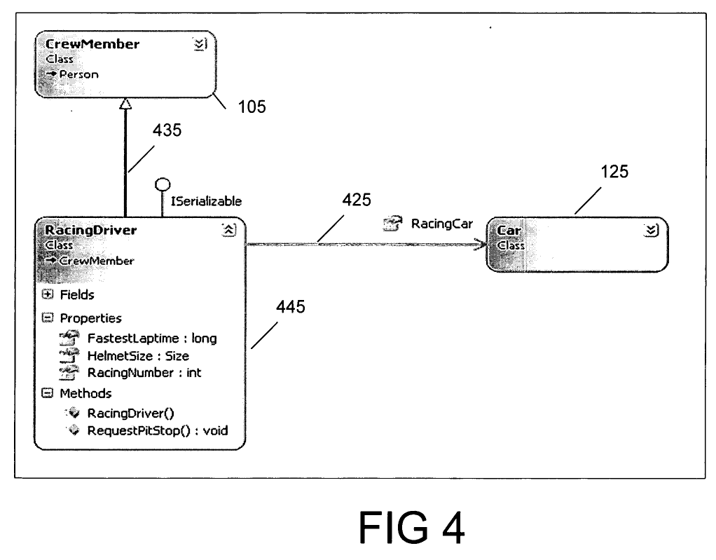

As shown in the exemplary screen shot at FIG. 4, the user has desirably re-linked the orphan shape 310 with the RacingDriver class, and the customizations associated with shape 115 have been automatically reapplied by the diagramming tool resulting in the shape 445. As shown, each of the customizations previously associated with shape 115 have been applied to shape 445 where applicable. For example, the width of shape 445 has been set to the width of the shape 115. Similarly, the class fields compartment 449 has been collapsed, and the same number of properties and methods are shown in shape 445 as in shape 115. Because the class RacingDriver still inherits from the class CrewMember and contains an instance of the class car, arrows 210 and 220 have been reconnected, as shown as arrows 435 and 425 respectively. Any customizations that no longer apply are desirably ignored or discarded, for example.

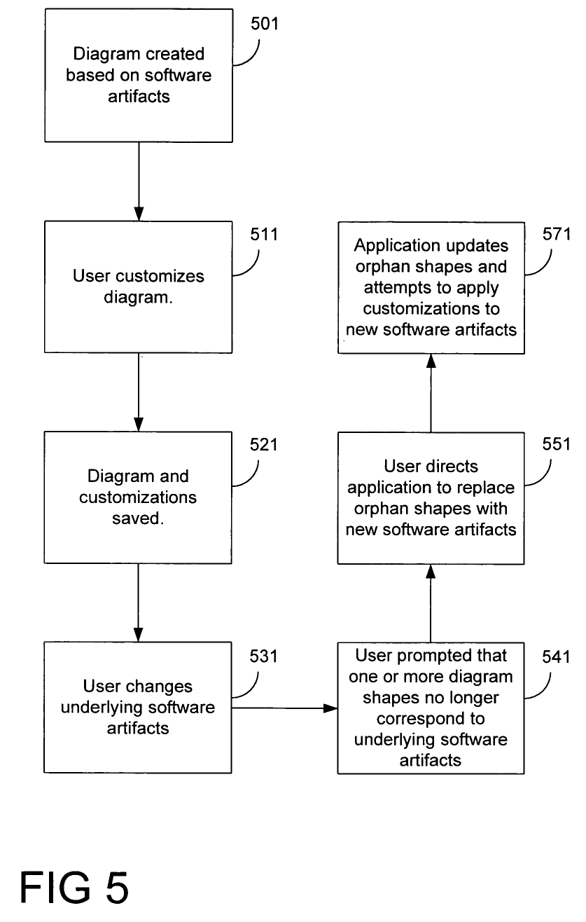

FIG. 5 illustrates an exemplary method for diagram shape synchronization in accordance with the present invention. A software diagram is created based on software artifacts of a software program, and the software diagram comprises shapes corresponding to the software artifacts. The user desirably customizes the diagram shapes to illustrate certain properties of the software artifacts or relationships between the software artifacts. The software diagram, including the shape customizations, is desirably saved. Later, one or more changes are made to one or more of the software artifacts such that the diagram no longer accurately reflects the program code. The diagramming tool desirably attempts to automatically update the software diagram to reflect the changed software artifacts, but may be unable to account for at least one diagram shape because its associated software artifact has changed such that the diagramming tool no longer recognizes it as the same software artifact. The unaccounted for shape is known as an orphan shape. The diagramming tool prompts the user regarding the orphan shape. The user desirably instructs the diagramming tool to associate the orphan shape with one of the changed software artifacts. The diagramming tool automatically reapplies the customizations previously associated with the orphan shape using the properties of the changed software artifact where applicable.

At 501, a software diagram is created based on software artifacts comprising a program or application. The diagram may be similar to the software diagram as described with respect to FIG. 1. The software diagram may be created by the user manually, or automatically by an analysis of the source code by a computer, for example. The software diagram desirably represents the software artifacts, and the relationships between the software artifacts, that comprise the source code. The software diagram may comprise a shape for each of the software artifacts in the associated program code, or the software diagram may comprise a subset of the software artifacts as chosen by the user, for example.

At 511, the user desirably customizes the diagram. As described further with respect to FIG. 2, the user may have particular preferences on how a particular shape is displayed in the diagram. For example, for a shape that represents an object class the user may desire to see all of the methods present on objects of that class. Accordingly, the user may select that all methods of that class be shown. For another class, the user may desire to see on the diagram only those methods that are publicly exposed from that class, i.e., methods that can be called from code outside of the given class. Similarly, the user may select that only public class methods are displayed for a particular shape. Other customizations may include, but are not limited to, shape colors, relationship or inherency lines between related classes, shape layout, for example.

At 521, the diagram, including the shapes and their respective user customizations, are desirably saved. The diagram may be saved using any system, method, or technique known in the art for saving a representation of a diagram and preserving shape customizations.

At 531, the user desirably makes one or more changes to the underlying code or software artifacts represented by the diagram. The user desirably changes the software artifacts in such a way that the diagram is no longer the intended representation of the current software artifacts. For example, a user may rename a particular object class, add a new object class, add new methods to an object class.

At 541, the user has desirably saved the software artifact changes and reopens the corresponding diagram. When the diagram is reopened, the software artifacts are desirably analyzed to determine if any significant changes have been made to the software artifacts. The artifacts may be analyzed using any system, method or technique known in the art for determining if changes have been made to software artifacts. Some software artifact additions or changes are recognized by the diagramming tool and easily incorporated into the diagram using conventional diagram synchronization heuristics.

Other code changes may not be recognized by the diagramming tool. These changes may include more drastic changes that cannot be rectified automatically with the available diagram synchronization heuristics. For these changes, the user is desirably prompted, or otherwise notified that there is a mismatch between the software artifacts and the software diagram that cannot automatically be fixed. For example, a particular diagram shape ‘A’ may have corresponded to an object of class ‘A’. Later, the object class may have been renamed ‘B’. When the diagram is reloaded after the code changes, the diagramming tool desirably attempts to update the diagram to reflect the software artifact changes. If the diagramming tool is unable to rectify the software artifacts with the previous diagram, the diagramming tool will desirably prompt the user. The diagramming tool may prompt the user by changing the color, for example, of the shape ‘A’ to indicate that the class ‘A’ is no longer present and display shape ‘A’ is an orphan shape, meaning that it has no corresponding software artifact associated with it, for example. The diagramming tool may also display a notification that a new software artifact class ‘B’ has been created. The new class ‘B’ may be displayed in a window containing all of the available software artifacts, for example. Any system, method, or technique known in the art for prompting a user may be used.

At 551, the user desirably attempts to correct the software diagram by associating the orphaned shape with the changed software artifact. Continuing the example from 541, the user desirably recognizes that the orphan shape ‘A’ should be linked or otherwise associated with the renamed software artifact class ‘B’. Accordingly, the user may direct the application to associate the orphan shape ‘A’ with the new class ‘B’ software artifact. The user may make the association by dragging the class ‘B’ into the orphan shape ‘A’, for example; however, any method, system, or technique known in the art for associating objects may be used.

At 571, the user has desirably directed the application to associate the orphan shape with the new software artifact. As described previously, each shape is desirably saved along with the customizations associated with that shape. In particular, the customizations associated with a shape desirably persist or remain associated with their corresponding orphan shapes until the particular orphan shape is deleted, or otherwise removed from the diagram. Accordingly, from the example above, when the user links orphan shape ‘A’ with the new software artifact ‘B’, the saved customizations associated with the orphan shape are desirably reapplied in light of the revised software artifact.

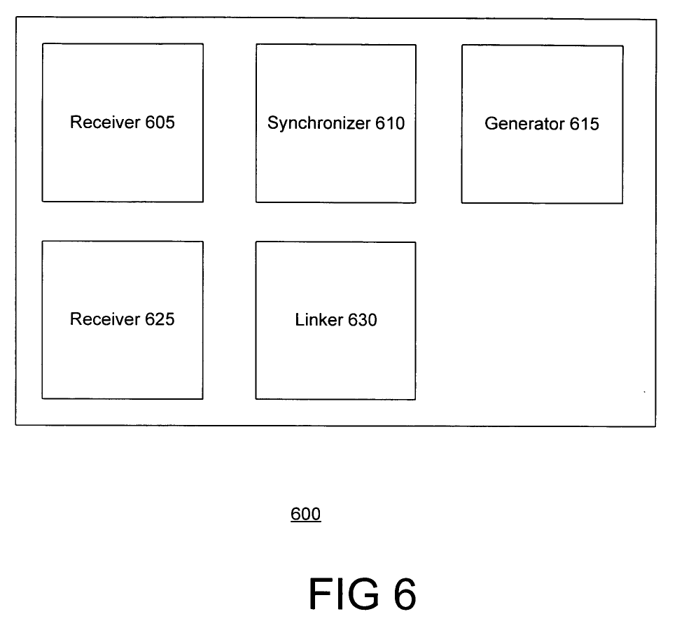

FIG. 6 is block diagram of an exemplary software diagramming system 600 in accordance with the present invention. The software diagramming system includes several means for performing functions. These means include a receiver 605, a synchronizer 610, a generator 615, a receiver 625, and a linker 630.

The receiver 605 receives a software diagram and associated software artifacts. The software diagram comprises shapes corresponding to one or more of the associated software artifacts. The shapes desirably have customizations associated with them. The receiver 605 can be any implemented using any suitable system, method or technique known in the art for receiving a software diagram and associated software artifacts. The receiver 605 can be implemented using software, hardware, or a combination of both.

The synchronizer 610 attempts to resynchronize the software diagram with the software artifacts after changes have been made to one or more of the software artifacts. The synchronizer 610 can be any implemented using any suitable system, method or technique known in the art for synchronizing a software diagram with its associated software artifacts. The synchronizer 610 can be implemented using software, hardware, or a combination of both.

The generator 615 generates a prompt or notification that one or more of the shapes could not be synchronized with the changed software artifacts. The prompt may be in the form of a text box or other on-screen notification, for example. In addition, an orphan shape may be displayed in place of any shape that cannot be synchronized. The generator 615 can be any implemented using any suitable system, method or technique known in the art for generating a prompt. The generator 615 can be implemented using software, hardware, or a combination of both.

The receiver 625 receives instruction on how to resynchronize the orphan shapes that cannot be synchronized with the software artifacts. The instructions are desirably supplied by a user or developer associated with the software diagram and associated software artifacts. The user desirably links, or otherwise directs, the diagramming tool to associate the orphan shapes with a software artifact. The available software artifacts may be displayed for the user in a window, for example. The receiver 625 can be any implemented using any suitable system, method or technique known in the art for receiving instructions from a user. The receiver 625 can be implemented using software, hardware, or a combination of both.

The linker 630 reapplies any customizations previously associated with the orphan shape to the orphan shape according to the software artifact specified by the user. As described previously with respect to FIG. 5, customizations may illustrate relationships between software artifacts, as well as certain details of the software artifacts that the user desires to convey in the software diagram. Accordingly, some of the customizations associated with the orphan shape may no longer be applicable to the new software artifact. Accordingly only those customizations that are still applicable to the new software artifact are applied. The linker 630 can be any implemented using any suitable system, method or technique known in the art for applying customizations. The linker 630 can be implemented using software, hardware, or a combination of both.

Exemplary Computing Environment

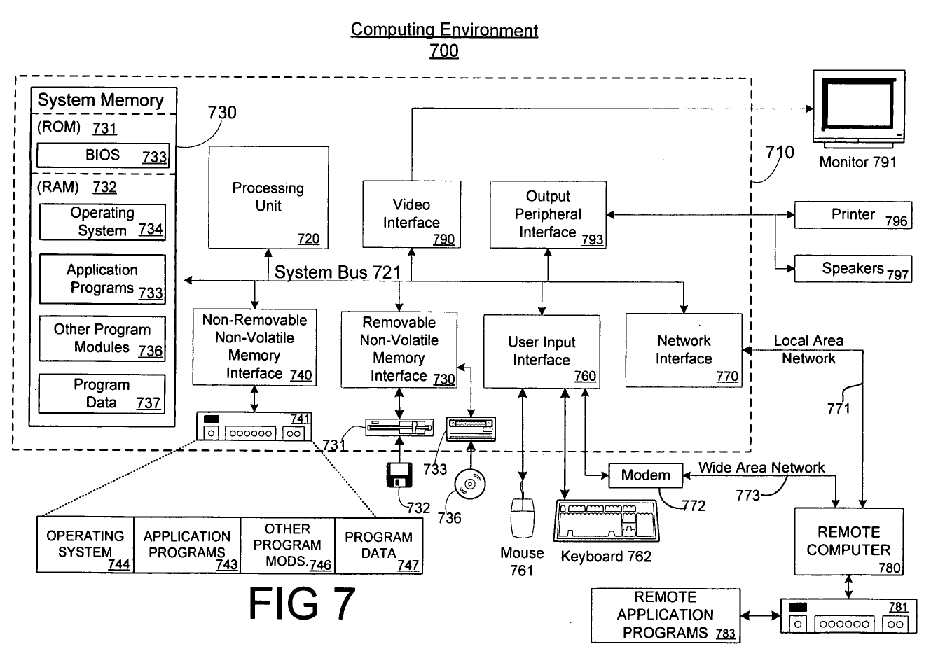

FIG. 7 illustrates an example of a suitable computing system environment 700 in which the invention may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing the invention includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 710 typically includes a variety of computer readable media. Computer readable media can be any available media that can be accessed by computer 710 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 730 includes computer storage media in the form of volatile and/or non-volatile memory such as ROM 731 and RAM 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 733, other program modules 736, and program data 737.

The computer 710 may also include other removable/non-removable, volatile/non-volatile computer storage media. By way of example only, FIG. 7 illustrates a hard disk drive 741 that reads from or writes to non-removable, non-volatile magnetic media, a magnetic disk drive 731 that reads from or writes to a removable, non-volatile magnetic disk 732, and an optical disk drive 733 that reads from or writes to a removable, non-volatile optical disk 736, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 731 and optical disk drive 733 are typically connected to the system bus 721 by a removable memory interface, such as interface 740.

The drives and their associated computer storage media provide storage of computer readable instructions, data structures, program modules and other data for the computer 710. In FIG. 7, for example, hard disk drive 741 is illustrated as storing operating system 744, application programs 743, other program modules 746, and program data 747. Note that these components can either be the same as or different from operating system 734, application programs 733, other program modules 736, and program data 737. Operating system 744, application programs 743, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 793.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted include a LAN 771 and a WAN 773, but may also include other networks. Such networking environments are commonplace in offices, enterprise-wide computer networks, intranets and the internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 783 as residing on memory device 781. It will be appreciated that the network connections shown are exemplary and other means of establishing a communications link between the computers may be used.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed:

1. A method for updating and maintaining a software diagram comprising:
receiving at least one customization to a shape on a software diagram based on software artifacts, wherein the software diagram comprises a plurality of shapes, wherein each shape corresponds to a software artifact;
changing the software artifact corresponding to the customized shape, wherein the software artifact is changed such that the changed software artifact is not recognizable as the original software artifact;
attempting to update the software diagram to reflect the change to the software artifact; and
displaying an orphan shape on the diagram in place of the customized shape associated with the changed software artifact.

2. The method of claim 1, further comprising generating a notification that the customized shape cannot be updated because its corresponding software artifact cannot be found.

3. The method of claim 1, further comprising linking the orphan shape to the changed software artifact, and automatically applying the customizations associated with the customized shape to the orphan shape.

4. The method of claim 3, wherein linking the orphan shape to the changed software artifact is performed by a user.

5. The method of claim 3, wherein the customizations are related to properties of the software artifact.

6. The method of claim 5, wherein automatically applying the customizations associated with the customized shape to the orphan shape comprises applying customizations related to properties that remain in the changed software artifact from the original software artifact.

7. The method of claim 1, wherein changing the software artifact comprises changing the name of the software artifact.

8. The method of claim 1, wherein changing the software artifact comprises changing the location of the software artifact.

9. The method of claim 1, wherein the software diagram is generated automatically by a diagramming tool.

10. A software diagramming tool, the software diagramming tool adapted to:
generate a software diagram based on source code, wherein the software diagram comprises a plurality of shapes, and each shape corresponds to a software artifact;
receive at least one customization to a shape on the software diagram;
attempt to update the software diagram to reflect a change to a software artifact, wherein the changed software artifact corresponds to the customized shape, and the software artifact is changed such that the changed software artifact is not recognizable as the original software artifact;
generate a notification that the customized shape cannot be updated because its corresponding software artifact cannot be found; and
generate an orphan shape on the diagram in place of the customized shape.

11. The software diagramming tool of claim 10, further comprising the software diagramming tool adapted to:
receive a request to link the orphan shape to the changed software artifact, and
apply the customizations associated with the customized shape to the orphan shape as a result of the request to link the shape to the changed software artifact.

12. The software diagramming tool of claim 11, wherein the customizations are related to properties of the software artifact.

13. The software diagramming tool of claim 12, wherein the software diagramming tool adapted to apply the customizations associated with the customized shape to the orphan shape comprises the diagramming tool adapted to apply the customizations related to properties that remain in the changed software artifact from the original software artifact.

14. The software diagramming tool of claim 10, wherein the change to the software artifact comprises a change of the name of the software artifact.

15. The software diagramming tool of claim 10, wherein the change to the software artifact comprises a change in the location of the software artifact.

16. A system for synchronizing a software diagram with software artifacts, comprising:
receiving means for receiving the software diagram and associated software artifacts, wherein the software diagram comprises shapes associated with software artifacts in the associated software code, and customizations associated with each of the shapes;
synchronizing means for synchronizing the software diagram with the associated software artifacts as a result of a change made to a software artifact, and
generating means for generating an orphan shape in place of the shape associated with the changed software artifact if the synchronizing means is unable to synchronize the software diagram with the associated software artifacts because the change made to the software artifact is such that the changed software artifact is not recognizable as the original software artifact.

17. The system of claim 16, further comprising:
receiving means for receiving instructions to associate the changed software artifact with the orphan shape; and
linking means for linking the changed software artifact with the orphan shape, and applying the customizations associated with the shape associated with the original software artifact to the orphan shape.
